(19) United States
(12) Patent Application Publication
(10) Pub. No.: US 2013/0055558 A1
(43) Pub. Date: Mar. 7, 2013

(54) METHOD FOR MANUFACTURING TOUCH PANEL

(71) Applicants: Youn Soo Kim, Seoul (KR); Hyun Jun Kim, Gyunggi-do (KR); Ji Soo Lee, Gyunggi-do (KR); Ho Joon Park, Seoul (KR); Sang Hwan Oh, Gyunggi-do (KR)

(72) Inventors: Youn Soo Kim, Seoul (KR); Hyun Jun Kim, Gyunggi-do (KR); Ji Soo Lee, Gyunggi-do (KR); Ho Joon Park, Seoul (KR); Sang Hwan Oh, Gyunggi-do (KR)

(73) Assignee: SAMSUNG ELECTRO-MECHANICS CO., LTD., Gyunggi-do (KR)

(21) Appl. No.: 13/425,765

(22) Filed: Mar. 21, 2012

(30) Foreign Application Priority Data
Sep. 6, 2011 (KR) 1020110090330

(51) Int. Cl. H01H 11/00

(52) U.S. Cl. 29/622

(57) ABSTRACT

Disclosed herein is a method for manufacturing a touch panel including: (A) applying a spinning solution including metal, a metal oxide, a conductive polymer, carbon nanotubes (CNTs), graphene, or any combination thereof to one surface of a transparent substrate through an electro spinning process to form an electrode layer; and (B) patterning the electrode layer by a laser to form a sensing electrode. Since sensing electrodes are formed through an electro spinning process without using high-priced equipment, the overall manufacturing costs of the touch panel can be reduced.

### CROSS REFERENCE TO RELATED APPLICATION

This application claims the benefit of Korean Patent Application No. 10-2011-0090330, filed on Sep. 6, 2011, entitled “Method for Manufacturing Touch Panel”, which is hereby incorporated by reference in its entirety into this application.

### BACKGROUND OF THE INVENTION

1. Technical Field

The present invention relates to a method for manufacturing a touch panel.

2. Description of the Related Art

In line with the advancement of computers using digital technologies, auxiliary systems of computers have been developed. A personal computer, a mobile transmission device, any other personal-dedicated information processing devices, or the like, perform text and graphic processing by using various input devices such as a keyboard, a mouse, or the like.

However, the purpose of computers has been widening due to a rapid transition into an information-oriented society, so keyboards and mouse currently serving as input devices cannot effectively driving products. Thus, the necessity of a device which may be simple, cause less erroneous manipulation, and allow any one to easily input information is increasing.

Also, interests on techniques regarding input devices have been changing toward high reliability, durability, innovativeness, design and processing-related techniques, beyond a level satisfying general functions, and to this end, a touch panel has been developed as an input device allowing input of information such as text, graphics, or the like.

The touch panel, installed on a display plane of a flat panel display such as an electronic notebook, a liquid crystal display (LCD) device, a plasma display panel (PDP), electroluminescence (EL), or the like, and an image display device such as a cathode ray tube (CRT), or the like, is a tool used for users to select desired information while viewing the image display device.

Meanwhile, types of touch panels are classified into a resistive type touch panel, a capacitive type touch panel, an electro-magnetic type touch panel, a surface acoustic wave (SAW) type touch panel, and an infrared type touch panel. The various types of touch panels are employed in electronic products in consideration of a problem of signal amplification, the difference in resolution, difficulty in a design and processing technique, optical characteristics, electrical characteristics, mechanical characteristics, environment-resistant characteristics, input characteristics, durability, economical efficiency, and the like. Currently, the resistive type touch panel and the capacitive type touch panel are commonly used in various fields extensively.

The touch panels include sensing electrodes for sensing a user's touch by using indium tin oxide (ITO), metal, conductive polymer, or the like. However, the sending electrodes of the prior art touch panel are formed through sputtering, physical vapor deposition (PVD), or the like, requiring high-priced equipment, so the prior art touch panel incurs high manufacturing costs, which degrade price competitiveness.

In addition, when the sensing electrodes are formed by using metal, in order to prevent the sensing electrodes are recognized by users, the sensing electrodes are patterned in the form of mesh after being deposited by sputtering or PVD. However, when the sensing electrodes are patterned in the form of mesh after deposition, since a line width is in micrometers (μm), users may recognize it, and in addition, since the mesh form has a latticed shape including regular and uniform intervals, a moiré phenomenon that degrades visibility occurs.

### SUMMARY OF THE INVENTION

The present invention has been made in an effort to provide a method for manufacturing a touch panel whose sensing electrodes are formed through an electro spinning process without using high-priced equipment, thus reducing manufacturing costs.

According to a first preferred embodiment of the present invention, there is provided a method for manufacturing a touch panel, including: (A) applying a spinning solution including metal, a metal oxide, a conductive polymer, carbon nanotubes (CNTs), graphene, or any combination thereof to one surface of a transparent substrate through an electro spinning process to form an electrode layer; and (B) patterning the electrode layer by a laser to form a sensing electrode.

The step (A) may include: providing the spinning solution to a spinning nozzle; disposing a current collector on the other surface of the transparent substrate; and applying the spinning solution from the spinning nozzle to one surface of the transparent substrate by applying a voltage between the spinning solution and the current collector to form the electrode layer.

In step (A), the metal may include copper (Cu), aluminum (Al), gold (Au), silver (Ag), titanium (Ti), palladium (Pd), chromium (Cr), or any combination thereof.

In step (A), the metal oxide may include indium tin oxide (110), antimony tin oxide (ATO), aluminum zinc oxide (AZO), or any combination thereof.

In step (A), the conductive polymer may include poly-3,4-ethylenedioxythiophene/polystyrenesulfonate (PEDOT/PSS), polyaniline, polyacetylene, polyphenylenevinylene, or any combination thereof.

Step (B) may include: disposing a patterned mask on the electrode layer; and patterning the electrode layer correspondingly according to the patterned mask by irradiating the laser to form the sensing electrode.

The method may further include: forming a plating layer on the electrode layer through an electroplating process (or electrodeposition), before step (B).

The plating layer may be made of copper (Cu), aluminum (Al), gold (Au), silver (Ag), titanium (Ti), palladium (Pd), chromium (Cr), or any combination thereof.

The method may further include: forming a plating layer on the sensing electrode through an electroplating process, after step (B).

The plating layer may be made of copper (Cu), aluminum (Al), gold (Au), silver (Ag), titanium (Ti), palladium (Pd), chromium (Cr), or any combination thereof.

According to a second preferred embodiment of the present invention, there is provided a method for manufacturing a touch panel, including: (A) applying photoresist to one surface of a transparent substrate; (B) patterning the photoresist through an exposure process and a developing process to form an open portion; (C) applying a spinning solution including metal, a metal oxide, a conductive polymer, carbon nanotubes (CNTs), graphene, or any combination thereof to the transparent substrate exposed through the open portion through an electro spinning process to form a sensing electrode; and (D) removing the photoresist.

Step (C) may include: providing the spinning solution to a spinning nozzle; disposing a current collector on the other surface of the transparent substrate; and applying the spinning solution from the spinning nozzle to the transparent substrate exposed from the open portion by applying a voltage between the spinning solution and the current collector to form the sensing electrode.

In step (C), the metal may include copper (Cu), aluminum (Al), gold (Au), silver (Ag), titanium (Ti), palladium (Pd), chromium (Cr), or any combination thereof.

In step (C), the metal oxide may include indium tin oxide (ITO), antimony tin oxide (ATO), aluminum zinc oxide (AZO), or any combination thereof.

In step (C), the conductive polymer may include poly-3,4-ethylenedioxythiophene/polystyrenesulfonate (PEDOT/PSS), polyaniline, polyacetylene, polyphenylenevinylene, or any combination thereof.

The method may further include: forming a plating layer on the sensing electrode through an electroplating process, after step (C).

The plating layer may be made of copper (Cu), aluminum (Al), gold (Au), silver (Ag), titanium (Ti), palladium (Pd), chromium (Cr), or any combination thereof.

### BRIEF DESCRIPTION OF THE DRAWINGS

FIGS. 1 through 5 are cross-sectional views sequentially showing a manufacturing process of a method for manufacturing a touch panel according to a first embodiment of the present invention;

FIGS. 6 through 12 are cross-sectional views sequentially showing a manufacturing process of a method for manufacturing a touch panel according to a second embodiment of the present invention; and

FIGS. 13 through 15 are cross-sectional views of a touch panel manufactured by using the preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In describing the present invention, a detailed description of related known functions or configurations will be omitted so as not to obscure the gist of the present invention.

Hereinafter, preferred embodiments of the present invention will be described in detail with reference to the accompanying drawings.

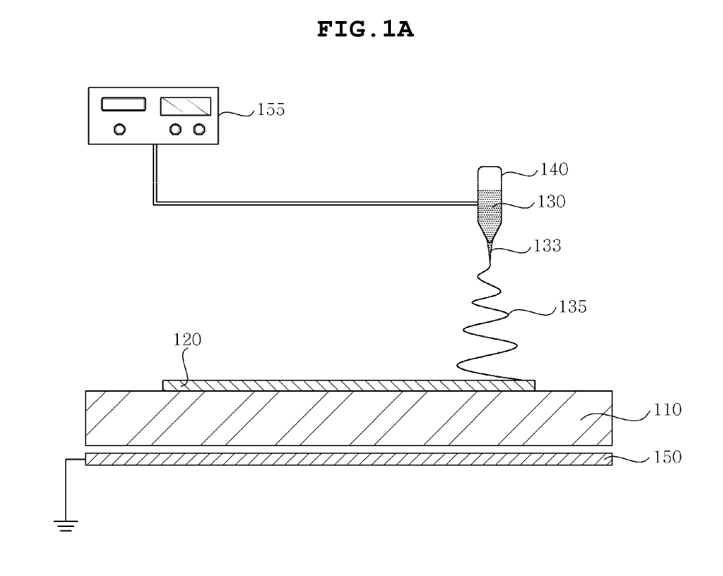

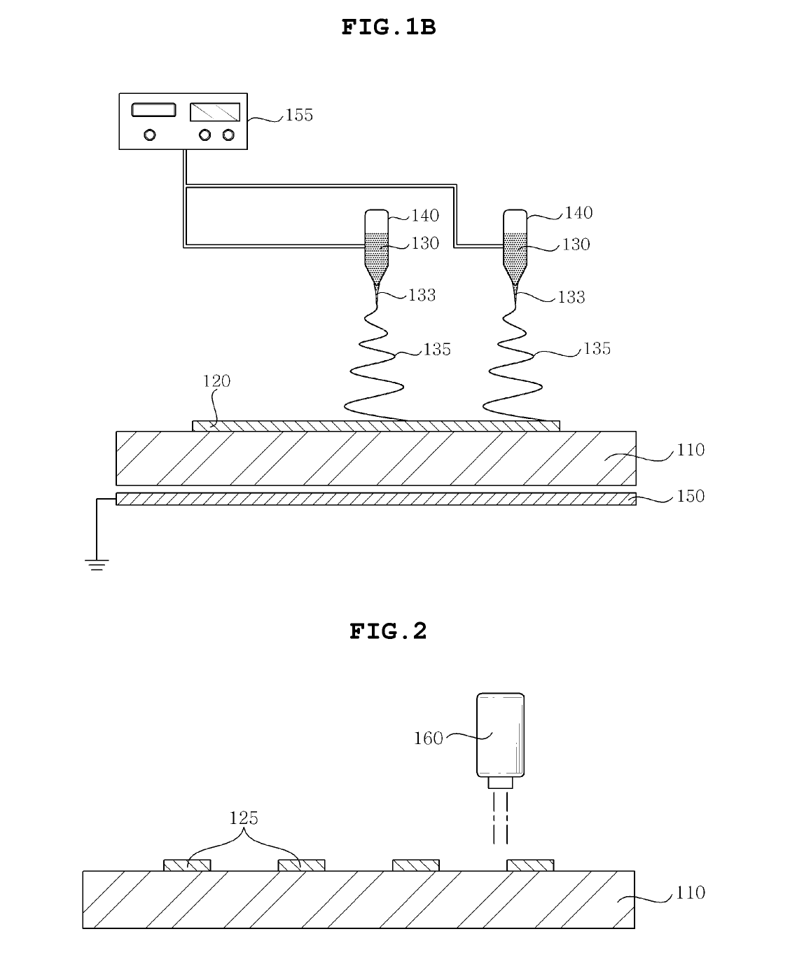

FIGS. 1 through 5 are cross-sectional views sequentially showing a manufacturing process of a method for manufacturing a touch panel according to a first embodiment of the present invention.

As shown in FIGS. 1 through 5, a method for manufacturing a touch panel 100 according to a preferred embodiment of the present invention includes (A) applying a spinning solution 130 including metal, a metal oxide, a conductive polymer, carbon nanotubes (CNTs), graphene, or any combination thereof to one surface of a transparent substrate 110 through an electro spinning process to form an electrode layer 120 on the entire surface, and (B) patterning the electrode layer 120 by a laser 160 to form sensing electrodes 125.

First, as shown in FIGS. 1A and 1B, the electrode layer 120 is formed on one surface of the transparent substrate 110. Here, the electrode layer 120 is formed by using the spinning solution 130. The spinning solution 130 is obtained by dispersing metal, a metal oxide, a conductive polymer, carbon nanotubes (CNTs), graphene, or any combination thereof together with a binder in a solvent. In detail, the metal may include copper (Cu), aluminum (Al), gold (Au), silver (Ag), titanium (Ti), palladium (Pd), chromium (Cr), or any combination thereof, and the metal oxide may include indium tin oxide (ITO), antimony tin oxide (ATO), aluminum zinc oxide (AZO), or any combination thereof. Also, the conductive polymer may include poly-3,4-ethylenedioxythiophene/polystyrenesulfonate (PEDOT/PSS), polyaniline, polyacetylene, polyphenylenevinylene, or any combination thereof.

The process of forming the electrode layer 120 through an electro spinning process will be described in detail as follows. First, the spinning solution 130 is provided to a spinning nozzle (or a capillary tube) 140, and a current collector 150 is disposed on the other surface of the transparent substrate 110 (i.e., the surface opposite to one surface of the transparent substrate 110 to which the spinning solution 130 is to be applied). Thereafter, voltage in the range of 10 kV to 20 kV is applied to the spinning solution 130 by a voltage supplier 155, and the current collector 150 is grounded to apply a certain voltage between the spinning solution 130 and the current collector 150. When the predetermined voltage is applied between the spinning solution 130 and the current collector 150, an electric field is applied to a fine drop of the spinning solution 130 hanging on the tip of the spinning nozzle 140 by surface tension, and accordingly, a charge is induced to the surface of the fine drop. Here, a mutual repulsive force of the induced charge is generated in the opposite direction of the surface tension of the fine drop. Due to the mutual repulsive force of the charge, the fine drop of the spinning solution 130 hanging on the tip of the spinning nozzle 140 is deformed into a tailor cone 133, and then, when the mutual repulsive force of the charge becomes stronger than the surface tension, a jet 135 of the spinning solution 130 assuming charge is discharged from the spinning nozzle 140. While the jet 135 of the spinning solution 130 is flying in the air, the solvent is volatilized, and the jet 135 of the spinning solution 130 is applied in the form of a web on one surface of the transparent substrate 110, forming the electrode layer 120 on the entire surface. Here, since the electrode layer 120 is formed in the form of a web through the electro spinning process, it can be implemented in the form of a mesh having a line width of a nanometer (nm) unit, so the user cannot recognize the electrode layer 120 and since the mesh form is irregular, a generation of a moiré phenomenon can be prevented. Thus, visibility of the touch panel 100 can be improved.

Also, in the process of forming the electrode layer 120 through the electro spinning process, using only one spinning nozzle 140 is not necessary. Namely, as shown in FIG. 1B, a plurality of spinning nozzles 140 may be used and different spinning solutions 130 may be provided to the respective spinning nozzles 140, whereby several materials may be mixed to form the electrode layer 120 (e.g., a mixture of copper PEDOT/PSS).

Meanwhile, the reason for disposing the current collector 150 on the other surface of the transparent substrate 110 in performing the electro spinning process is because the transparent substrate 110 is a non-conductor which cannot be grounded. Here, the material of the transparent substrate 110 may not be particularly limited. Namely, the transparent substrate 110 may be made of polyethyleneterephthalate (PET), polycarbonate (PC), polymethylmethacrylate (PMMA), polyethylenenaphthalate (PEN), polyethersulfone (PES), a cyclic olefin copolymer (COC), a triacetylcellulose (TAC) film, a polyvinyl alcohol (PVA) film, a polyimide (PI) film, polystyrene (PS), biaxially oriented polystyrene (K-resin containing biaxially oriented PS (BOPS)), glass, tempered glass, or the like. For example, when the transparent substrate 110 is a flexible substrate made of polyethyleneterephthalate (PET), process efficiency can be enhanced through roll-to-roll process. Or, when the transparent substrate 110 is a substrate having excellent support force such as glass or tempered glass, a large-scale transparent substrate 110 may be provided to form the electrode layer 120 thereon, which may be then cut into cell units. However, when the transparent substrate 110 is made of glass or tempered glass, the large scale transparent substrate 110 may not be necessarily cut into cell units, but the transparent substrate 110 by cell unit may be provided as necessary to form the electrode layer 120.

Next, as shown in FIG. 2, the electrode layer 120 is patterned by the laser 160 to form the sensing electrodes 120. In the foregoing step, the electrode layer 120 has been formed on the entire surface of the transparent substrate 110, so in the present step, patterning is performed to selectively remove the electrode layer 120 to form the sensing electrodes 125. Here, the electrode layer 120 may be patterned to have various shapes such as a diamond-like shape, a quadrangular shape, a triangular shape, a circular shape, or the like, by using the laser 160 to form the sensing electrodes 125.

Also, as the laser 160 for patterning the electrode layer 120, a CO₂ layer, a YAG laser, an Excimer laser, a fiber laser, or the like, may be used, but the present invention is not limited thereto and any type of processing lasers known in the art may be used.

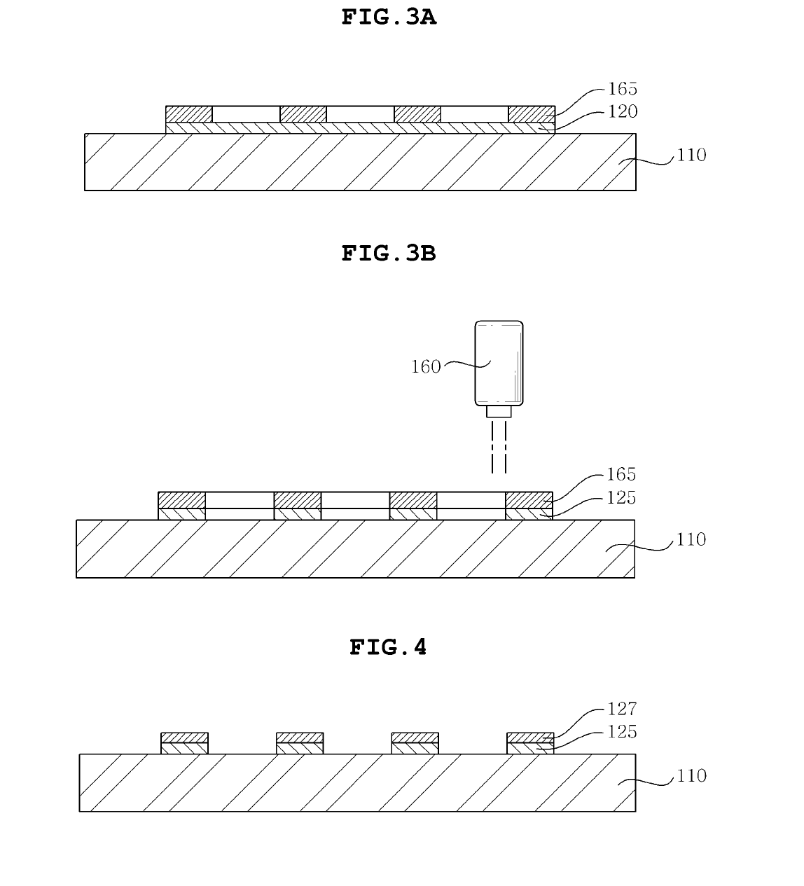

Meanwhile, the electrode layer 120 may be precisely patterned by accurately controlling the laser 160, but as shown in FIGS. 3A and 3B, a mask 165 may be disposed and the laser 160 may be irradiated thereto to pattern the electrode layer 120, as necessary. In detail, the patterned mask 165 may be disposed on the electrode layer 120 (See FIG. 3A), and then, the laser 160 is irradiated to the electrode layer 120 (See FIG. 3B). Then, portions of the electrode layer 120 on which the patterned mask 165 is disposed are not removed, whereby the electrode layer 120 is patterned to correspond to the patterned mask 165 to thus form the sensing electrodes 125. In this manner, since the electrode layer 120 is patterned by the laser 160 by using the mask 165, the electrode layer 120 can be very accurately patterned. Also, since the patterned mask 165 is used, the laser 160 is not required to be precisely controlled, improving the speed for forming the sensing electrodes 125 by patterning the electrode layer 120.

When the touch panel is touched by an input device, the sensing electrodes 125 formed through the foregoing process generate a signal to allow a controller to recognize touched coordinates.

In addition, as shown in FIG. 4, the plating layer 127 may be formed on the sensing electrodes 125 through an electroplating process. Since the plating layer 127 is formed through the electroplating process, surface resistance of the sensing electrodes 125 can be eventually lowered. Here, the plating layer 127 may be made of copper (Cu), aluminum (Al), gold (Au), silver (Ag), titanium (Ti), palladium (Pd), chromium (Cr), or any combination thereof. Meanwhile, the electroplating process may not be necessarily performed until after the sensing electrodes 125 are formed by patterning the electrode layer 120. Namely, before forming the sensing electrodes 125 by patterning the electrode layer 120, the plating layer 127 may be formed on the electrode layer 120 through the electroplating process, and then, patterned together with the electrode layer 120 when the electrode layer is patterned 120.

Here, of course, the step of forming the plating layer 127 through the electroplating process is not an indispensible process in forming the sensing electrodes 125, so the step may be omitted, as necessary. Thus, in the following drawings, the plating layer 127 is omitted.

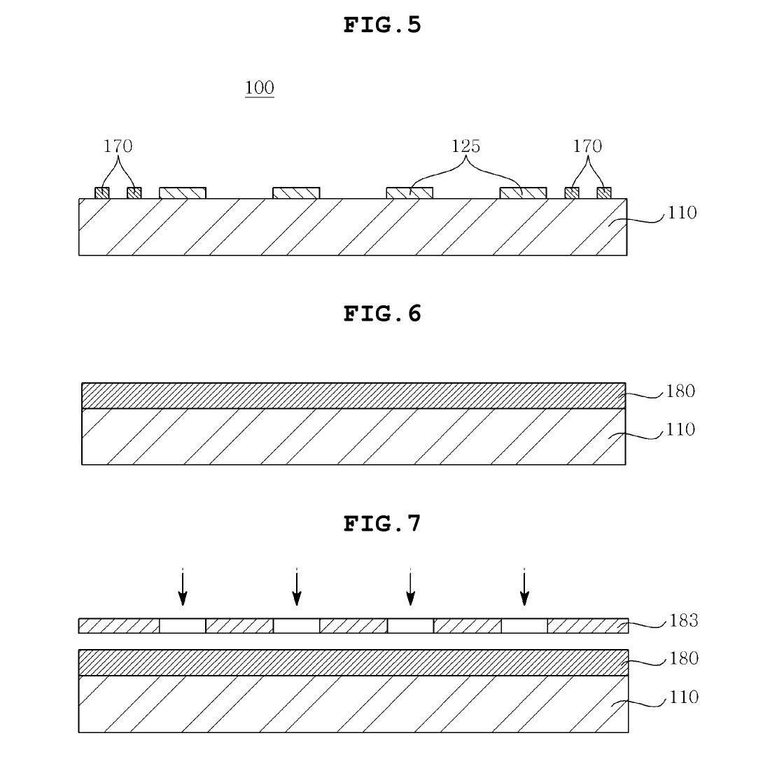

And then, as shown in FIG. 5, electrode wirings 170 are formed on the edges of the sensing electrodes 125. Here, the electrode wirings 170, which receive an electrical signal from the sensing electrodes 125, may be formed by using screen printing, Gravure printing, inkjet printing, or the like. However, the electrode wirings 170 may not be necessarily formed separately from the sensing electrodes 125. Namely, when the sensing electrodes 125 are formed through patterning using the electro spinning process and the laser 160, the electrode wirings 170 may also be formed through patterning using the electro spinning process and the laser 160.

FIGS. 6 through 12 are cross-sectional views sequentially showing a manufacturing process of a method for manufacturing a touch panel according to a second embodiment of the present invention.

As shown in FIGS. 6 to 12, a method for manufacturing the touch panel 100 according to the second embodiment of the present invention includes A) applying photoresist 180 to one surface of a transparent substrate 110, (B) patterning the photoresist 180 by an exposure process and a developing process to form open portions 185, (C) applying a spinning solution 130 including metal, a metal oxide, a conductive polymer, carbon nanotubes (CNTs), graphene, or any combination thereof to the transparent substrate 110 exposed through the open portions 185 by an electro spinning process to form sensing electrodes 125, and (D) removing the photoresist 180.

Compared with the first embodiment as described above, the most significant difference between the first and second embodiments is a patterning method. Namely, in the first embodiment as described above, patterning is performed by using the laser 160, while in the present embodiment, patterning is performed through a photolithography process using the photoresist 180. Thus, in the present embodiment, the patterning method through a photolithography process using the photoresist 180 will be described.

First, as shown in FIG. 6, the photoresist 180 is applied to one surface of the transparent substrate 110. Here, as the photoresist 180, a dry film, a liquid photoresist, or the like, may be used. For example, when a dry film is used as the photoresist 180, it may be applied to the transparent substrate 110 by using a laminator. Also, when a liquid photoresist is used as the photoresist 180, it may be applied to the transparent substrate 110 through screen coating, tip coating, roll coating, or the like. In addition, after the photoresist 180 is applied to the transparent substrate 110, a prebaking process may be performed thereon.

Next, as shown in FIG. 7, an artwork film 183 is disposed on the photoresist 180 and then cured, excluding portions where the open portions 185 are to be formed, through an exposure process of irradiating light (indicated by the arrows). In detail, when the photoresist 180 is a positive type photoresist, light is irradiated only to portions, where the open portions 185 are to be formed, of the photoresist 180, and when the photoresist 180 is a negative type photoresist, light is irradiated to portions, excluding the portions where the open portions 185 are to be formed, of the photoresist 180.

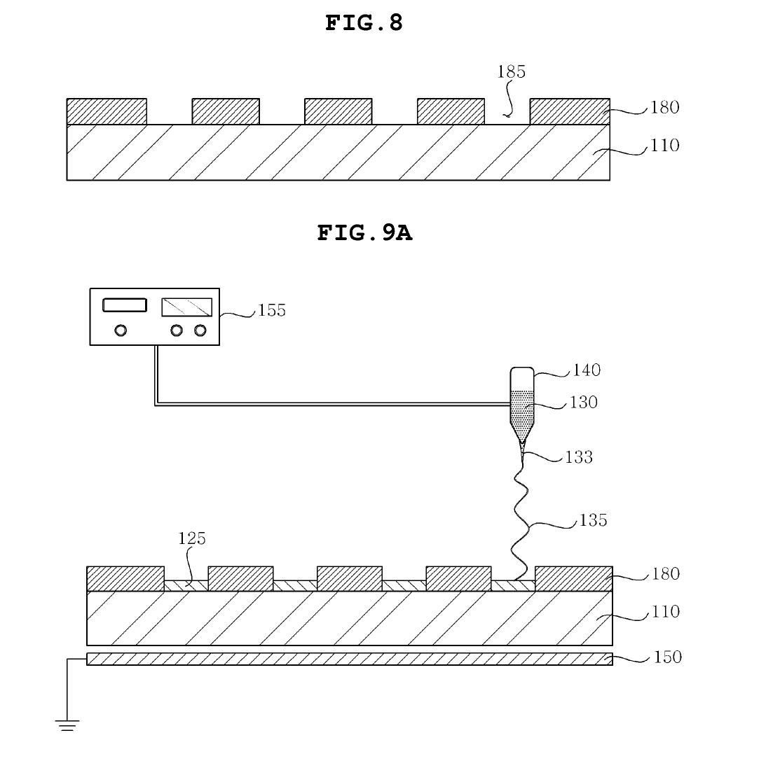

And then, as shown in FIG. 8, the photoresist 180 is patterned to form the open portions 185 by a developing process. In detail, since the portions, where the open portions 185 to be formed, of the photoresist 180 have not been cured, so the portions where the open portions 185 are to be formed are dissolved with a developer (sodium carbonate or potassium carbonate) so as to be removed. As a result, the open portions 185 are formed in the photoresist 180 by the developing process, and the transparent substrate 110 is exposed through the open portions 185.

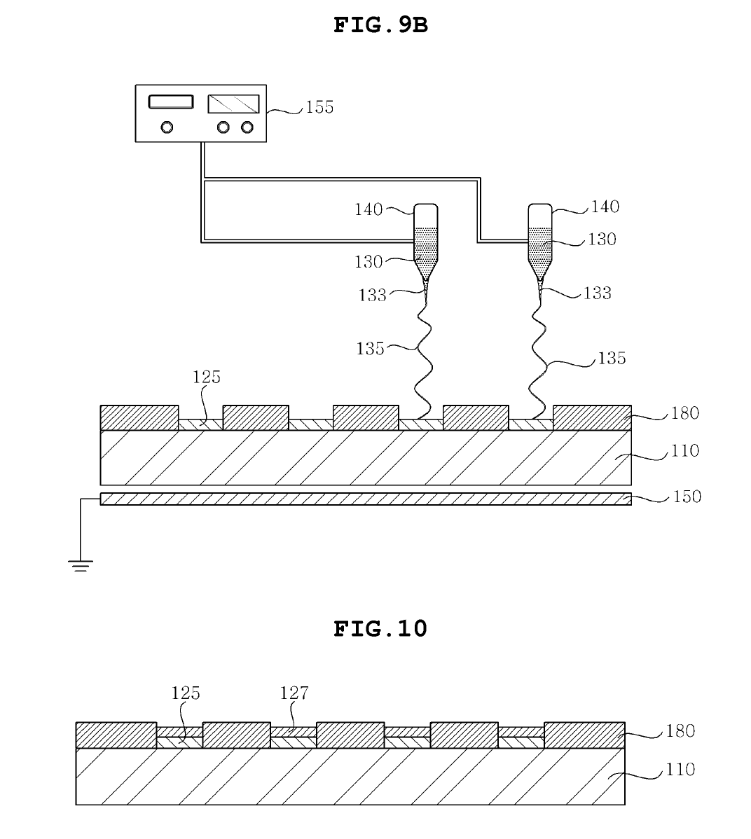

Thereafter, as shown in FIGS. 9A and 9B, the sensing electrodes 125 are formed on the transparent substrate 110 exposed from the open portions 185. Here, the sensing electrodes 125 are formed by using the spinning solution 130. The spinning solution 130 is obtained by dispersing metal, a metal oxide, a conductive polymer, carbon nanotubes (CNTs), graphene, or any combination thereof together with a binder in a solvent. In detail, the metal may include copper (Cu), aluminum (Al), gold (Au), silver (Ag), titanium (Ti), palladium (Pd), chromium (Cr), or any combination thereof, and the metal oxide may include indium tin oxide (ITO), antimony tin oxide (ATO), aluminum zinc oxide (AZO), or any combination thereof. Also, the conductive polymer may include poly-3,4-ethylenedioxythiophene/polystyrenesulfonate (PEDOT/PSS), polyaniline, polyacetylene, polyphenylenevinylene, or any combination thereof.

The process of forming the sensing electrodes 125 through an electro spinning process will be described in detail as follows. First, the spinning solution 130 is provided to a spinning nozzle (or a capillary tube) 140, and a current collector 150 is disposed on the other surface of the transparent substrate 110 (i.e., the surface opposed to one surface of the transparent substrate 110 to which the photoresist 180 was applied). Thereafter, voltage of 10 kV to 20 kV is applied to the spinning solution 130 by a voltage supplier 155, and the current collector 150 is grounded to apply a certain voltage between the spinning solution 130 and the current collector 150. When the certain voltage is applied between the spinning solution 130 and the current collector 150, an electric field is applied to a fine drop of the spinning solution 130 hanging on the tip of the spinning nozzle 140 by surface tension, and accordingly, a charge is induced to the surface of the fine drop. Here, a mutual repulsive force of the induced charge is generated in the opposite direction of the surface tension of the fine drop. Due to the mutual repulsive force of the charge, the fine drop of the spinning solution 130 hanging on the tip of the spinning nozzle 140 is deformed into a tailor cone 133 shape, and then, when the mutual repulsive force of the charge becomes stronger than the surface tension, a jet 135 of the spinning solution 130 assuming one of the charges is discharged from the spinning nozzle 140. While the jet 135 of the spinning solution 130 is flying in the air, the solvent is volatilized, and the jet 135 of the spinning solution 130 is applied in the form of a web on the transparent substrate 110 (the portions exposed from the open portions 185), forming the sensing electrodes 125. Unlike the foregoing first embodiment, in the present embodiment, before performing the electro spinning process, the photoresist 180 is applied and then patterned to form the open portions 185. Thus, when the electro spinning process is performed, the jet 135 of the spinning solution 130 can be selectively applied only to the transparent substrate 110 exposed from the open portions 185, and at the same time, the sensing electrodes 125 can be formed. Also, since the sensing electrode 125 is formed in the form of a web through the electro spinning process, it can be implemented in the form of a mesh having a line width of a nanometer (nm) unit, so the user cannot recognize the sensing electrodes 125 and since the mesh form is irregular, a generation of a moiré phenomenon can be prevented. Thus, visibility of the touch panel 100 can be improved.

Also, in the process of forming the sensing electrodes 125 through the electro spinning process, one spinning nozzle 140 may not be necessarily used. Namely, as shown in FIG. 9B, a plurality of spinning nozzles 140 may be used and different spinning solutions 130 may be provided to the respective spinning nozzles 140, whereby several materials may be mixed to form the sensing electrodes 125 (e.g., a mixture of copper PEDOT/PSS).

Meanwhile, the reason for disposing the current collector 150 on the other surface of the transparent substrate 110 in performing the electro spinning process is because the transparent substrate 110 is a non-conductor which cannot be grounded. Here, the material of the transparent substrate 110 may not be particularly limited. Namely, the transparent substrate 110 may be made of polyethyleneterephthalate (PET), polycarbonate (PC), polymethylmethacrylate (PMMA), polyethylenenaphthalate (PEN), polyethersulfone (PES), a cyclic olefin copolymer (COC), a triacetylcellulose (TAC) film, a polyvinyl alcohol (PVA) film, a polyimide (PI) film, polystyrene (PS), biaxially oriented polystyrene (K-resin containing biaxially oriented PS (BOPS)), glass, tempered glass, or the like.

In addition, as shown in FIG. 10, the plating layers 127 may be formed on the sensing electrodes 125 by the electroplating process. Since the plating layer 127 is formed through the electroplating process, surface resistance of the sensing electrodes 125 can be eventually lowered. Here, the plating layer 127 may be made of copper (Cu), aluminum (Al), gold (Au), silver (Ag), titanium (Ti), palladium (Pd), chromium (Cr), or any combination thereof.

Here, of course, the forming of the plating layer 127 by the electroplating process is not an indispensible process in forming the sensing electrodes 125, so the step may be omitted as necessary. Thus, in the following drawings, the plating layer 127 is omitted.

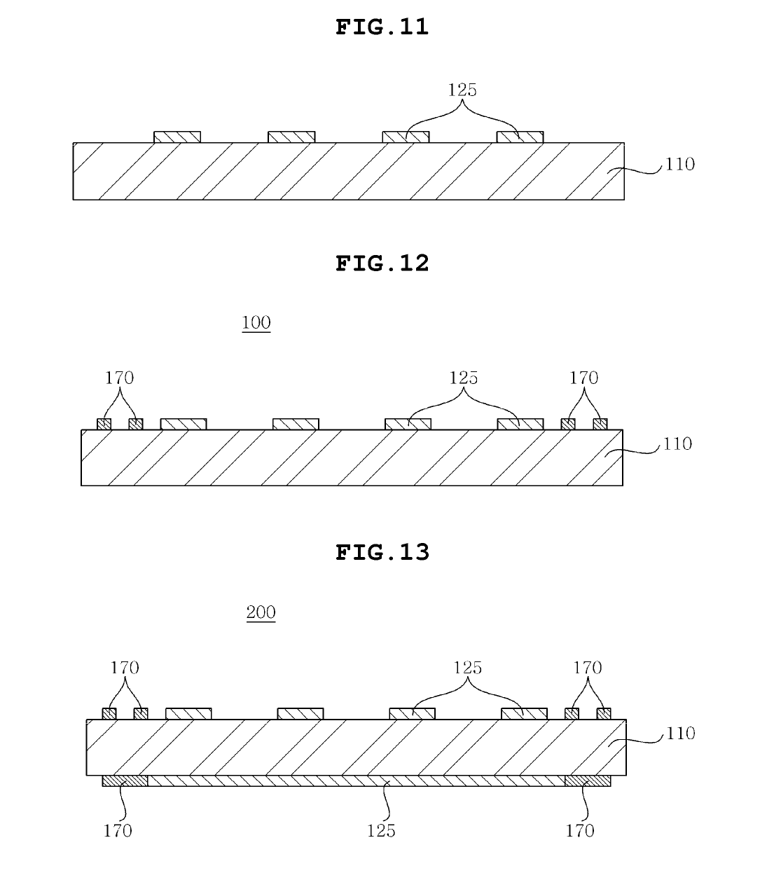

As shown in FIG. 11, the photoresist 180 is removed. After the sensing electrodes 125 are formed on the transparent substrate 110 exposed from the open portions 185 through the electro spinning process, the photoresist 180 has completed its role, so it is removed. Here, the photoresist 180 may be removed through a stripping liquor such as sodium hydroxide, potassium hydroxide, or the like.

Thereafter, as shown in FIG. 12, electrode wirings 170 are formed on the edges of the sensing electrodes 125. Here, the electrode wirings 170, which receive an electrical signal from the sensing electrodes 125, may be formed by using screen printing, Gravure printing, inkjet printing, or the like. However, the electrode wirings 170 may not be necessarily formed separately from the sensing electrodes 125. Namely, when the sensing electrodes 125 are formed through the lithography process and the electro spinning process using the photoresist 180, the electrode wirings 170 may also be formed through the lithography process and the electro spinning process using the photoresist 180.

As shown in FIG. 5 or FIG. 12, in the case of the touch panel 100 according to an embodiment of the present invention, a self-capacitive type touch panel or a mutual capacitive type touch panel can be manufactured by using the sensing electrodes 125 having the uni-layered structure. However, the touch panel according to the present invention is not limited thereto, and various types of touch panels including the foregoing configuration may be manufactured (to be described).

FIGS. 13 through 15 are cross-sectional views of a touch panel manufactured by using the preferred embodiment of the present invention.

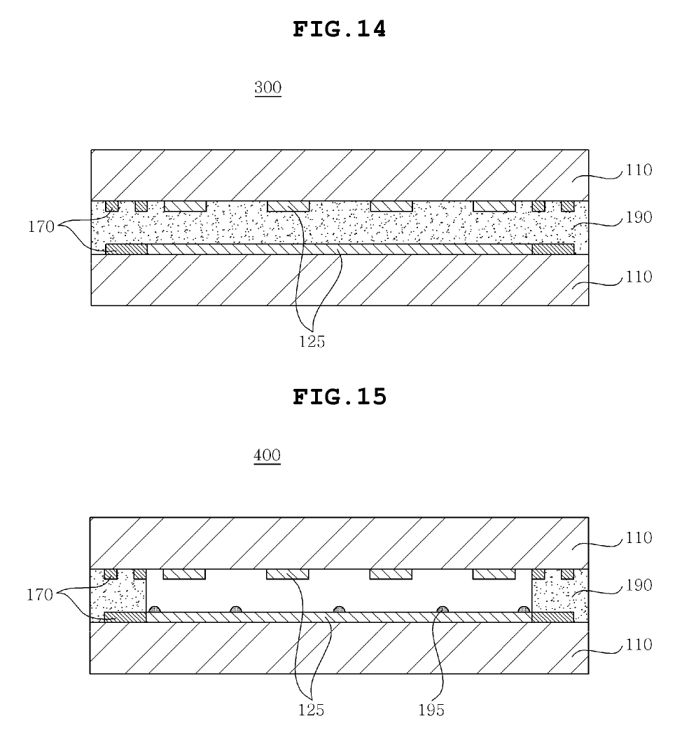

As shown in FIG. 13, a mutual capacitive type touch panel 200 (See FIG. 13) may be manufactured by forming the sensing electrodes 125 on both sides of the transparent substrate 110, respectively. Also, as shown in FIGS. 14 and 15, a mutual capacitive type touch panel 300 (See FIG. 14) or a digital resistive type touch panel 400 (See FIG. 15) may be manufactured by providing two transparent substrates 110, each having the sensing electrode 125 formed on one surface thereof, and bonding the two transparent substrates 110 with an adhesive layer 190 such that the sensing electrodes 125 face each other. Here, in the case of the mutual capacitive type touch panel 300 illustrated in FIG. 14, the adhesive layer 190 is attached on the entire surface of the transparent substrate 110 in order to insulate the two facing sensing electrodes 125. Meanwhile, in the case of the digital resistive type touch panel 400 illustrated in FIG. 15, the adhesive layer 190 is attached only to the edges of the transparent substrate 110 such that the two facing sensing electrodes 125 can be brought into contact when a pressure of an input device is applied, and dot spacers 195 are provided on the exposed surface of the sensing electrode 125 in order to provide a repulsive force such that the sensing electrodes 125 are returned to their original position when the pressure of the input device is eliminated.

According to the preferred embodiments of the present invention, since the sensing electrodes are formed through an electro spinning process without using high-priced equipment, the overall manufacturing costs of the touch panel can be reduced.

Also, according to the preferred embodiments of the present invention, since the sensing electrodes are irregularly formed in a mesh form having a line width of a nanometer (nm) unit through an electro spinning process, an occurrence of a moiré phenomenon can be prevented, thus improving visibility of the touch panel.

Although the embodiments of the present invention has been disclosed for illustrative purposes, it will be appreciated that a method for manufacturing a touch panel according to the invention is not limited thereby, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. A method for manufacturing a touch panel, the method comprising:
(A) applying a spinning solution including metal, a metal oxide, a conductive polymer, carbon nanotubes (CNTs), graphene, or any combination thereof to one surface of a transparent substrate through an electro spinning process to form an electrode layer; and
(B) patterning the electrode layer by a laser to form a sensing electrode.

2. The method as set forth in claim 1, wherein the applying step further includes:
providing the spinning solution to a spinning nozzle;
disposing a current collector on the other surface of the transparent substrate; and
applying the spinning solution from the spinning nozzle to one surface of the transparent substrate by applying a voltage between the spinning solution and the current collector to form the electrode layer.

3. The method as set forth in claim 1, wherein, in the applying step, the metal includes copper (Cu), aluminum (Al), gold (Au), silver (Ag), titanium (Ti), palladium (Pd), chromium (Cr), or any combination thereof.

4. The method as set forth in claim 1, wherein, in the applying step, the metal oxide includes indium tin oxide (ITO), antimony tin oxide (ATO), aluminum zinc oxide (AZO), or any combination thereof.

5. The method as set forth in claim 1, wherein, in the applying step, the conductive polymer includes poly-3,4-ethylenedioxythiophene/polystyrenesulfonate (PEDOT/PSS), polyaniline, polyacetylene, polyphenylenevinylene, or any combination thereof.

6. The method as set forth in claim 1, wherein the patterning step further includes:
disposing a patterned mask on the electrode layer; and
patterning the electrode layer correspondingly according to the patterned mask by irradiating the laser to form the sensing electrode.

7. The method as set forth in claim 1, further comprising:
forming a plating layer on the electrode layer through an electroplating process, before the patterning step.

8. The method as set forth in claim 7, wherein the plating layer is made of copper (Cu), aluminum (Al), gold (Au), silver (Ag), titanium (Ti), palladium (Pd), chromium (Cr), or any combination thereof.

9. The method as set forth in claim 1, wherein further comprising:
forming a plating layer on the sensing electrode through an electroplating process, after the patterning step.

10. The method as set forth in claim 9, wherein the plating layer is made of copper (Cu), aluminum (Al), gold (Au), silver (Ag), titanium (Ti), palladium (Pd), chromium (Cr), or any combination thereof.

11. A method for manufacturing a touch panel, the method comprising:
(A) applying photoresist to one surface of a transparent substrate;
(B) patterning the photoresist through an exposure process and a developing process to form an open portion;
(C) applying a spinning solution including metal, a metal oxide, a conductive polymer, carbon nanotubes (CNTs), graphene, or any combination thereof to the transparent substrate exposed through the open portion through an electro spinning process to form a sensing electrode; and
(D) removing the photoresist.

12. The method as set forth in claim 11, wherein applying a spinning solution further includes:
providing the spinning solution to a spinning nozzle;
disposing a current collector on the other surface of the transparent substrate; and
applying the spinning solution from the spinning nozzle to the transparent substrate exposed from the open portion by applying a voltage between the spinning solution and the current collector to form the sensing electrode.

13. The method as set forth in claim 11, wherein, in the step of applying a spinning solution, the metal includes copper (Cu), aluminum (Al), gold (Au), silver (Ag), titanium (Ti), palladium (Pd), chromium (Cr), or any combination thereof.

14. The method as set forth in claim 11, wherein, in the step of applying a spinning solution, the metal oxide includes indium tin oxide (ITO), antimony tin oxide (ATO), aluminum zinc oxide (AZO), or any combination thereof.

15. The method as set forth in claim 11, wherein, in the step of applying a spinning solution, the conductive polymer includes poly-3,4-ethylenedioxythiophene/polystyrenesulfonate (PEDOT/PSS), polyaniline, polyacetylene, polyphenylenevinylene, or any combination thereof.

16. The method as set forth in claim 11, further comprising:
forming a plating layer on the sensing electrode through an electroplating process, after the step of applying a spinning solution.

17. The method as set forth in claim 16, wherein the plating layer is made of copper (Cu), aluminum (Al), gold (Au), silver (Ag), titanium (Ti), palladium (Pd), chromium (Cr), or any combination thereof.
